(19) United States
(12) Patent Application Publication
(10) Pub. No.: US 2021/0387605 A1
(43) Pub. Date: Dec. 16, 2021

(54) Pneumatic Brake for a Rail Vehicle

(71) Applicant: Siemens Mobility Austria GmbH, Wien (AT)

(72) Inventors: Christoph HÖRMANN, Wien (AT); Harald SCHNEIDER, Wien (AT)

(21) Appl. No.: 17/285,645

(22) PCT Filed: Sep. 16, 2019
(86) PCT No.: PCT/EP2019/074699

§ 371 Date: Apr. 15, 2021

(30) Foreign Application Priority Data
Oct. 16, 2018 (AT) A 50894/2018

(51) Int. Cl. B60T 15/02; B60T 15/04; B60T 15/50

(52) U.S. Cl. CPC B60T 15/021; B60T 15/50; B60T 15/048

(57) ABSTRACT

A pneumatic brake for a rail vehicle, wherein friction linings are pressed against friction partners during a braking process via pneumatic pressure from a brake air container that is fed from a compressed air supply, where the filling and the outflow of compressed air from the brake air container occurs via a flow limiting device.

### CROSS-REFERENCE TO RELATED APPLICATIONS

This is a U.S. national stage of application No. PCT/2019/074699 filed 16 Sep. 2019. Priority is claimed on Austrian Application No. A50894/2018 filed 16 Oct. 2018, the content of which is incorporated herein by reference in its entirety.

### BACKGROUND OF THE INVENTION

### 1. Field of the Invention

The invention relates to braking systems and, more particularly to a pneumatic brake for a rail vehicle.

### 2. Description of the Related Art

Rail vehicles are overwhelmingly fitted with pneumatic brakes. Two significant embodiments can be distinguished here. In a first embodiment, which is mainly used for standard railroads, the pneumatic pressure acts in a cylinder and presses a friction lining onto an opposite surface. Here, the compressed air is supplied via a compressed air line extending throughout the train, via which auxiliary air reservoirs arranged in the cars are filled. The application of the brakes is initiated by reducing the pressure in the compressed air line, where a control valve uses the pressure stored in the auxiliary air reservoirs to press on the friction linings. The advantage of this embodiment is that if the pressure supply fails or a leak occurs, then braking is performed automatically. In the case of other trains, such as subway trains, brakes are also used in which the pneumatic pressure for pressing the brake linings is regulated by an electrically actuated brake valve. In this embodiment, a defect in the pneumatic system is more critical, and in addition a series of further systems is frequently supplied from the same compressed air system (e.g., door drives, coupling actuation, flange lubrication) so that the number of potentially faulty components and thus the probability of failure of the entire compressed air system is increased. This can be countered by increasing redundancy, where, for example, multiple air compressors are provided, distributed over the train. Even if a component fails, for example, all brakes of a chassis, the braking rate values required for approval must still be guaranteed. To this end, what are known as brake air reservoirs can be used, which store the compressed air needed for the immediate braking operations and thus form a buffer between the brake system and the general compressed air supply. This means that even if the general compressed air supply fails, some braking operations can still be performed, because the actual brake system is connected to the general compressed air supply via a non-return valve that prevents a return flow from the brake system if the air pressure in the general compressed air system drops. A brake air reservoir can be provided for each chassis, so that any failure of a brake air reservoir affects the brakes of one chassis. However, if only one brake air reservoir is provided per vehicle, all the brakes of a vehicle would be out of operation in the event of a failure (e.g., leak, destruction, or falling off the vehicle) of the brake air reservoir. Likewise, a failure of a brake air reservoir means that the rest of the compressed air system, e.g., the door drives, are likewise no longer operable. The space available on the chassis or beneath the underframe is restricted. Consequently, it is desirable for just one brake air reservoir to have to be provided per car, although failure of this single reservoir, however, means the loss of all the brakes of a car.

### SUMMARY OF THE INVENTION

In view of the foregoing, it is therefore an object of the invention to provide a pneumatic brake for a rail vehicle that remains operable even if a brake air reservoir fails.

This and other objects and advantages are achieved in accordance with the invention by a rail vehicle and a pneumatic brake for the rail vehicle in which during a braking operation friction linings are pressed onto friction partners via pneumatic pressure from a brake air reservoir, where the brake air reservoir is fed from a compressed air supply and where the filling and outflow of compressed air from the brake air reservoir occurs via a flow limiting device.

As a result, the advantage can be achieved that even in the event of a loss of pressure maintenance in the brake air reservoir the operational capability of the brakes is still retained, at least with reduced braking capacity. The reason why the pressure maintenance in the brake air reservoir has been reduced or has failed is irrelevant, here. If there is a compressed air supply in the vehicle, then braking operations can continue to be performed even if the brake air reservoir fails.

In accordance with the invention, a flow limiting device is arranged in the supply line to the brake air reservoir, via which each inflow and outflow of compressed air occurs.

If a failure in pressure maintenance in the brake air reservoir occurs, then the flow limiting device reduces the volume flow of the compressed air flowing out of the brake system to a level that can be subsequently delivered from the compressed air supply without an excessive pressure drop thereby occurring.

During the filling of the brake air reservoir the use of the flow limiting device is irrelevant because, although the filling therefore occurs more slowly, this does not represent a disadvantage due to the substantially shorter brake setup time when compared to the fill times. The air reservoir is filled from the compressed air supply both during the journey and while the vehicle is stationary, and compressed air is removed from the brake air reservoir only directly during the pressurization in the brake cylinders. In vehicles fitted with wheel slip protection, a repeated discharge of compressed air and subsequent refilling of the brake cylinders occurs during braking with an engagement of the wheel slip protection system, as a result of which the consumption of compressed air is increased. Even in this operative state, a brake in accordance with the invention can make the compressed air needed for braking available.

In a first advantageous embodiment of the invention, the flow limiting device is formed from a Here, the forward direction of the non-return valve is oriented from the brake air reservoir to the brake system. In this way, compressed air can flow rapidly out of the brake air reservoir to the brake cylinders during the braking operation, such that even when the invention is used no disadvantageous braking behavior occurs, because the braking pressure can be built up just as rapidly as without the flow limiting device. In the event of a loss of pressure maintenance in the brake air reservoir, compressed air flows out of the compressed air supply into the environment via the nozzle, rather than via the non-return valve that, in this case, is self-closing. The -drop in the pneumatic system occurring due to the outflow of the compressed air via the nozzle is determined by the open cross-section of the nozzle. The nozzle should be dimensioned such that, in the event of a failure, an impermissibly low pressure does not occur in the brake system that reduces the braking behavior, i.e., the potential braking rate. Here, the nozzle can be provided with a fixed cross-section, or a variable, adjustable nozzle can be employed.

In a preferred embodiment of the invention provides, the non-return valve and the nozzle are formed as a unit with one common housing. Thanks to this embodiment as a restrictor non-return valve the complexity of the pneumatic tubing of the brake system can be reduced.

In a further preferred embodiment of the invention, the flow limiting device is formed as an overflow valve. An overflow valve such as this means that the compressed air does not flow until a particular absolute pressure is reached and in one form it comprises a non-return valve for the direction of drainage out of the brake air reservoir toward the brakes. Using an overflow valve means that even in the event of a failure, no pressure loss occurs in the brake system.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention along with embodiments and advantages are explained by way of example in the following using the drawings, in which:

FIG. 1 is a schematic illustration of a brake system with a flow limiting device in accordance with the invention; and

FIG. 2 is a schematic illustration of the brake system of FIG. 1 with a flow limiting device formed as an overflow valve.

### DETAILED DESCRIPTION OF THE EXEMPLARY EMBODIMENTS

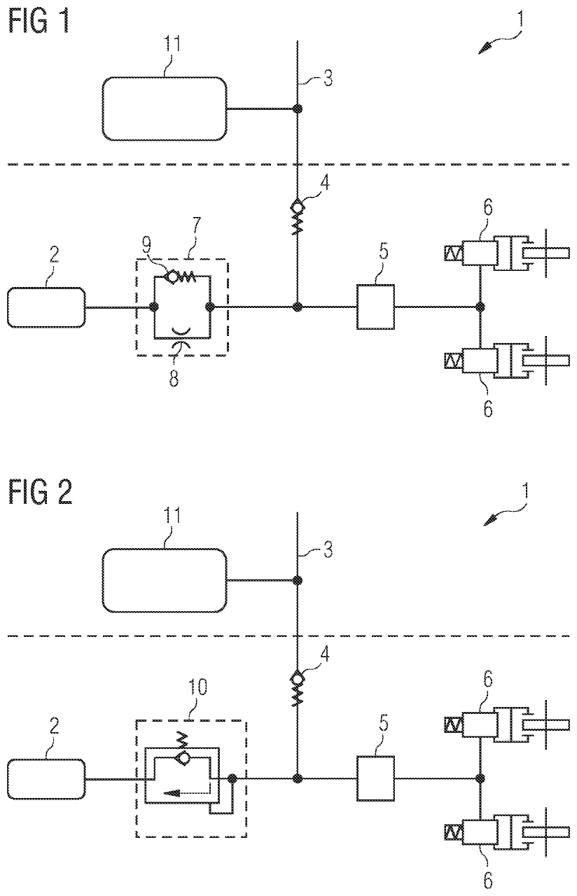

FIG. 1 shows by way of example and schematically a brake system with a flow limiting device. The pneumatic circuit diagram of part of a compressed air system of a rail vehicle with a pneumatic brake 1 is illustrated. A compressed air supply 3 is fitted with a main air reservoir 11, which serves to supply compressed air, such that even when the requirement for compressed air is briefly high, the pressure in the pneumatic system does not drop sharply. The compressed air system comprises a plurality of further components, such as compressors, pressure regulators, measuring devices and consumer loads such as door drives, or folding step drives. To simplify the illustration, these are not shown in FIG. 1.

The pneumatic brake system 1 is supplied with compressed air from the general compressed air system, where a brake non-return valve 4 prevents the return flow of compressed air from the pneumatic brake system 1 into the general compressed air system. Thus, the pressure in the pneumatic brake system 1 is maintained even if the general compressed air system is out of operation, e.g., because of a defect in one of its components, and the pressure in it drops or disappears completely. The pneumatic brake system 1 comprises a brake valve 5 that can be actuated by the train crew or the vehicle control system and which in this case conducts a pneumatic pressure proportional to the desired braking rate to the brake actuators 6. The brake actuators 6 each comprise a pneumatic cylinder, the force action of which is used to press brake linings onto brake disks. In the exemplary illustrated embodiment, two brake actuators 6 are represented in the embodiment as disk brakes. However, the number and embodiment of the brake actuators 6 is unimportant. The pneumatic brake 1 is furthermore fitted with a brake air reservoir 2 that has a supply of air available exclusively for braking operations and that is also filled from the compressed air supply 3 via the brake non-return valve 4. In conventional brake systems, in the event of a defect (loss of pressure maintenance) in this brake air reservoir 2 the pneumatic pressure in the pneumatic brake 1 would, as a function of the cross-section of the opening through which compressed air escapes and the volume flow continuing to flow out of the compressed air supply 3, drop so sharply that in some cases no further braking would be possible In accordance with the disclosed embodiments of the invention, a restrictor non-return valve 7 is therefore arranged in the supply line to the brake air reservoir 2, and comprises a parallel connection of a restrictor 8 and a non-return valve 9. In the event of a loss of pressure maintenance of the brake air reservoir 2, the pneumatic brake 1 thus vents into the open air via the restrictor 8, where because of the outflow opening restricted by the nozzle 8 the pressure drop in the pneumatic brake 1 is sharply reduced and in any case still permits braking so long as the compressed air supply 3 is in operation. The non-return valve 9 connected in parallel to the nozzle 8 permits a rapid removal of compressed air, uninfluenced by the nozzle 8, from the brake air reservoir 2 in normal operation. The brake air reservoir 2 is filled from the compressed air supply 3 at a somewhat reduced rate because of the nozzle 8. In specific embodiments, pressure measurement devices are also provided at the pneumatic brake 1, via which a pressure drop can be identified; these are not illustrated in FIG. 1.

FIG. 2 shows by way of example and schematically a brake system with a flow limiting device formed as an overflow valve. The pneumatic circuit diagram of part of a compressed air system of a rail vehicle with a pneumatic brake 1 as in FIG. 1 is illustrated. Except for the flow limiting device, all the components are identical. In the exemplary illustrated embodiment, this flow limiting device is constructed as an overflow valve 10 that, in the event of a loss of pressure maintenance of the brake air reservoir 2, prevents an unrestricted outflow of compressed air, which thus ensures that the air pressure in the pneumatic brake 1 remains sufficient for braking operations.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-5. (canceled)

6. A pneumatic brake for a rail vehicle, comprising:
a compressed air supply;
a brake air reservoir fed from the compressed air supply; and
a flow limiting device;
wherein during a braking operation friction linings are pressed onto friction partners via pneumatic pressure from the brake air reservoir;
wherein the filling and outflow of compressed air from the brake air reservoir occurs via the flow limiting device.

7. The pneumatic brake for a rail vehicle as claimed in claim 6, wherein the flow limiting device consists of a parallel connection of a non-return valve and a restrictor.

8. The pneumatic brake for a rail vehicle as claimed in claim 6, wherein the flow limiting device comprises an overflow valve.

9. The pneumatic brake for a rail vehicle as claimed in claim 7, wherein the flow limiting device is formed as a restrictor non-return valve with a non-return valve and a restrictor in one common housing.

10. A rail vehicle, comprising the pneumatic brake as claimed in claim 6.
